(19) United States
(12) Patent Application Publication
(10) Pub. No.: US 2001/0022838 A1
(43) Pub. Date: Sep. 20, 2001

(54) System and a method within private telecommunication

(76) Inventors: Anders Jacobsson, Gustavsberg (SE); Arne Ohlsson, Norrtalje (SE); Jan Bengtsson, Stockholm (SE); Hakan Karlsson, Stockholm (SE); Ola Andersson, Hasselby (SE); Staffan Sjodin, Tyreso (SE); Ghasem Naghavi, Stockholm (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/737,326

(22) Filed: Dec. 14, 2000

(30) Foreign Application Priority Data
Dec. 14, 1999 (SE) 9904563-5

(51) Int. Cl. H04M 7/00

(52) U.S. Cl. 379/219; 379/221.15

(57) ABSTRACT

The present invention relates to a private telecommunications system comprising a number of switching arrangements (NA, NB) and using an asymmetrical protocol supporting set up of virtual calls between two switching arrangements for transfer of information. Means are provided for creating a call reference in the first switching arrangement (NA) when a first virtual call is to be set up from the first switching arrangement (NA) to a second switching arrangement (NB), storing means being provided in said first and second switching arrangements (NA, NB) for storing said call reference. Said first virtual call is released while all internal connections and the end points related to it are kept, and a second virtual call is set up in the direction opposite to that of the first virtual call using said call reference such that symmetrical transfer of information is enabled between the two switching arrangements (NA, NB).

### FIELD OF THE INVENTION

The present invention relates to a private telecommunications system comprising a number of switching arrangements and using an asymmetrical protocol supporting set up of virtual calls between switching arrangements for transfer of information without requiring set up of a real speech channel. The invention also relates to a method for enabling transfer of information between a first and a second switching arrangement in a private telecommunications system using an asymmetric protocol supporting set up of virtual calls for information transfer which protocols are such that they allow a higher transmission capacity in one direction than the other.

### STATE OF THE ART

Some protocols used in private telecommunications systems are asymmetric protocols having a higher capacity of information transfer in one direction than in the other. They may implement setting up virtual calls for transferring information between switching arrangements or exchanges without requiring set up of a speech channel. Normally, it is used for some kind of supplementary service or, in more general terms, such calls are used for short information transfer. For example, in the DPNSS 1 protocol (Digital Private Network Signalling System No. 1) specified by British Telecommunications, BTNR 188, Issue 6 January 1995, it is possible to set up calls without using a speech channel which calls are denoted virtual calls. According to the DPNSS 1 specification virtual calls are treated as normal calls, but all the service specifications in the DPNSS 1 specification show but one way to handle virtual calls, namely initial call set up followed by an immediate release of the call without ever going into an active call state, which generally is interpreted by manufacturers as being the only way to handle virtual calls. A problem relates to the specific case when more data than one message can carry has to be transferred in the backward direction, which as such would require segmentation of messages. The only messages in the backward direction that can be segmented are only allowed in an active state according to the DPNSS 1 specification, which thus makes it impossible to transfer an amount of information corresponding to more than one message in the backward direction. Generally, it is a problem with the implementation of such virtual calls due to the lack of information about virtual calls in the specifications, particularly in the DPNSS 1 specification. Furthermore, due to this spare information, it is possible that different manufacturers interpret how virtual calls are to be handled in different manners, and, finally, the handling of segmentation of messages according to the DPNSS 1 protocol is not clear and segmentation is only allowed in the forward direction, i.e. in the direction that a virtual call is initiated.

Thus, if more data needs to be transferred in the backward direction than can be carried by a single message, one solution consists in setting up a real call instead of a virtual call. This is disadvantageous in so far as speech channels will then have to be occupied even if actually no speech information is transferred, which means that the call processing capacity that remains for normal calls will be reduced.

Another approach that has been used is to use a speech channel for the actual information transfer. This is advantageous in so far as, in principle, an unlimited amount of data can be transferred. However, it is a disadvantage, just as with the solution discussed above, that a speech channel has to be used which reduces the normal call handling capacity.

Both the solutions described above, moreover, are disadvantageous in so far as they violate the idea of using virtual calls, since they actually do not use virtual calls for data transfer.

### SUMMARY OF THE INVENTION

What is needed is, therefore, a mechanism through which it is possible to transfer more information than can be carried by one single message by means of the implementation of virtual calls. Particularly, a telecommunications system is needed implementing an asymmetric protocol as referred to above, in which it is possible to transfer as much data in the backward direction as in the forward direction while still taking advantage of the principle of using virtual calls. Particularly, a system is needed through which non-speech information can be transferred without wasting speech channel resources. Therefore, also a method is needed through which information data can be transferred through the use of virtual calls, particularly allowing transfer of more information than can be carried by one message using virtual calls. Still further, a method is needed through which a symmetrical transfer of data by virtue of virtual calls is enabled in both directions between two switching arrangements. Particularly, a method is needed through which transfer of segmented messages is permitted in both directions between two switching arrangements, particularly not only in the forward direction, but also in the backward direction, wherein the forward direction means the direction in which an initial call is initiated from a first to a second switching arrangement.

Therefore, a private telecommunications system as initially referred to is provided, in which a call reference is created when a first virtual call is set up from a first switching arrangement to a second switching arrangement, storing means being provided for storing the call reference in said first and second switching arrangements. Said first virtual call is released while all internal connections and the end points related to said first virtual call are kept and a second virtual call is set up in the direction opposite to that of the first virtual call using said call reference such that symmetrical transfer of information is allowed between the two switching arrangements. Particularly, segmented messages, i.e. more than one message, can be transferred in both directions, which means that more information than can be carried by one single message can be transferred also in the backward direction through the use of virtual calls. Even more particularly, a call reference comprises system specific data and it is sent from the first to the second switching arrangement with a message (set up message) initiating the first virtual call (thus enabling transfer of segmented messages in the first direction which, however, might not be needed if for example the first virtual call relates to a request for information from the second switching arrangement to the first switching arrangement, the important thing with the present invention being that a larger amount of data than contained in a single message can be transferred from the second to the first switching arrangement, i.e. from the switching arrangement to which the first virtual call is set up.)

Even more particularly, the second switching arrangement sends a call release message initiating release of the first virtual call to the first switching arrangement which acknowledges the release of the first virtual call, but keeps its internal connections related to it. Even more particularly, the first virtual call can be set up via a number of transit switching arrangements. Connections to such transit exchanges are released upon acknowledgement of the release of the first virtual call by the first switching arrangement. Still further, the second virtual call is advantageously initiated by the second switching arrangement, and, particularly, as said second virtual call is initiated, transfer of one or more information messages is started. Advantageously, the first switching arrangement comprises means for sending a call release message to the second switching arrangement when information transfer is detected to be completed. According to different embodiments the switching arrangements may comprise PBX:es (Private Branch Exchange). Alternatively, they comprise mobility serving means, such as mobility servers as more specifically described in U.S. patent application Ser. Nos. 08/948,522 and 08/786,552 the contents of which herewith are incorporated by reference thereto. Alternatively, one of the switching arrangements comprises a PBX, whereas the other comprises a mobility server.

Particularly, the asymmetric protocol is DPNSS 1. However, also for other asymmetric protocols the inventive concept is applicable.

In a particular implementation the first switching arrangement is a node which is visited by a roaming mobile station and the second switching arrangement comprises the home location node or contains home location data of the roaming mobile station, the information transferred to the first switching arrangement comprising at least authentication information relating to the roaming mobile station.

Therefore, there is also provided a method for enabling symmetric transfer of information between a first and a second switching arrangement in a private telecommunications system using an asymmetric protocol supporting set up of virtual calls for transfer of information data and allowing a higher transmission capacity in one direction than in the other, which method comprises the steps of:

creating a call reference for a first virtual call in the first switching arrangement;

storing the call reference in the first switching arrangement;

sending the call reference to the second switching arrangement with a message initiating the first virtual call;

storing the call reference in the second switching arrangement; and

initiating a release of the first virtual call from the second switching arrangement;

keeping only the internal connections relating to the first virtual call in the first and the second switching arrangements;

initiating a second virtual call from the second switching arrangement and in the direction opposite to that of the first virtual call using the call reference of the first virtual call;

initiating transfer of information from the second to the first switching arrangement using one or more messages.

Particularly, the method comprises the step of, in at least one direction, transferring segmentated messages upon initiation of a virtual call in the same direction as the virtual call is set up.

Particularly, the method includes the step of, in at least one direction, particularly in the backward direction from the second switching arrangement to the first switching arrangement, transferring segmentated messages upon initiation of a virtual call in the same direction as the virtual call is set up. Particularly, the step of creating a call reference comprises creating system specific data, for instance specific data defining a call reference of a virtual call. Still further, the method includes the step of, at acknowledging the release of the first virtual call in the first switching arrangement, releasing any transit exchange connections related to the virtual call.

The method may additionally include the step of releasing the second virtual call from the first switching arrangement when information transfer is completed. Still further, in a particular implementation, the telecommunications system uses the DPNSS signalling protocol. Even more particularly, the amount of information that can be transferred as segmented data comprises up to 135 octets of data. Still further, the switching arrangements particularly comprise PBX:es and/or mobility serving means such as a mobility server including a PBX functionality or associated with a PBX, respectively.

Still further, the method particularly includes the steps of:

setting up a first virtual call from a first switching arrangement into which a mobile station is roaming to a second switching arrangement containing home location data of the roaming mobile station;

transferring data requested, e.g. authentication information, by the first switching arrangement from the second switching arrangement to said first switching arrangement.

Therefore, there is also provided a method for enabling symmetric transfer of information between a first and a second switching arrangement in a private telecommunications system using an asymmetric protocol allowing a higher transmission capacity in one direction than in the other, opposite, direction, and supporting set up of virtual calls for information transfer. The method comprises the steps of:

setting up a first virtual call between the first and the second switching arrangement;

releasing the first virtual call,

using a call reference common with a call reference created at set up of the first virtual call for setting up a second virtual call in the direction opposite to that of the first virtual call between the second and the first switching arrangements;

using the second virtual call for initiating transfer of information in messages, which may be segmented if there is more data to transfer than can be carried in one message from the second to the first switching arrangement.

It is an advantage of the invention that more information can be transferred in the backward direction than it can be with hitherto known mechanisms, and particularly that messages can be segmented also in the backward direction which enables saving of speech channel resources.

### BRIEF DESCRIPTION OF THE DRAWINGS

The invention will in the following be further described in a non-limiting way and with reference to the accompanying drawings, in which:

FIG. 1 schematically illustrates the signalling between a first and a second switching arrangement implementing the inventive concept,

FIG. 2 schematically illustrates the signalling between a first and a second switching arrangement between which an intermediate transit network arrangement is provided,

FIG. 3 schematically illustrates the signalling between two switching arrangements in a network using DPNSS 1, and

FIG. 4 is a flow diagram illustrating the case when transfer of information data is carried out in the backward direction between two switching arrangements through the use of virtual calls.

### DETAILED DESCRIPTION OF THE INVENTION

According to the invention two virtual calls are used for information transfer in the backward direction, i.e. from a switching arrangement to which a first virtual call is set up. More precisely, the solution consists in providing and keeping a call reference in order to relate the two virtual calls which are set up in opposite directions to each other. In general terms, when the first virtual call in the forward direction is released, a second virtual call is set up in the opposite direction. This can also be interpreted as a virtual call being reverted. However, when speaking of a first and a second virtual call, also the second virtual call can be segmented and for example if the DPNSS 1 signalling system is used, rules for segmentation are given in the DPNSS 1 specification.

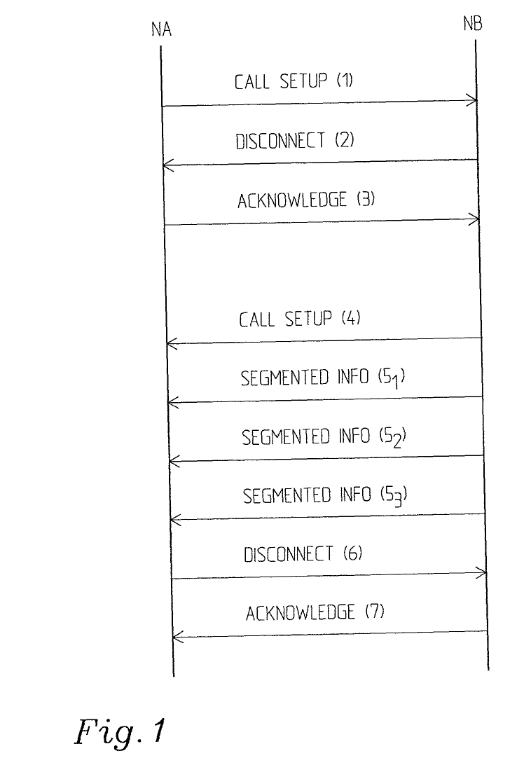

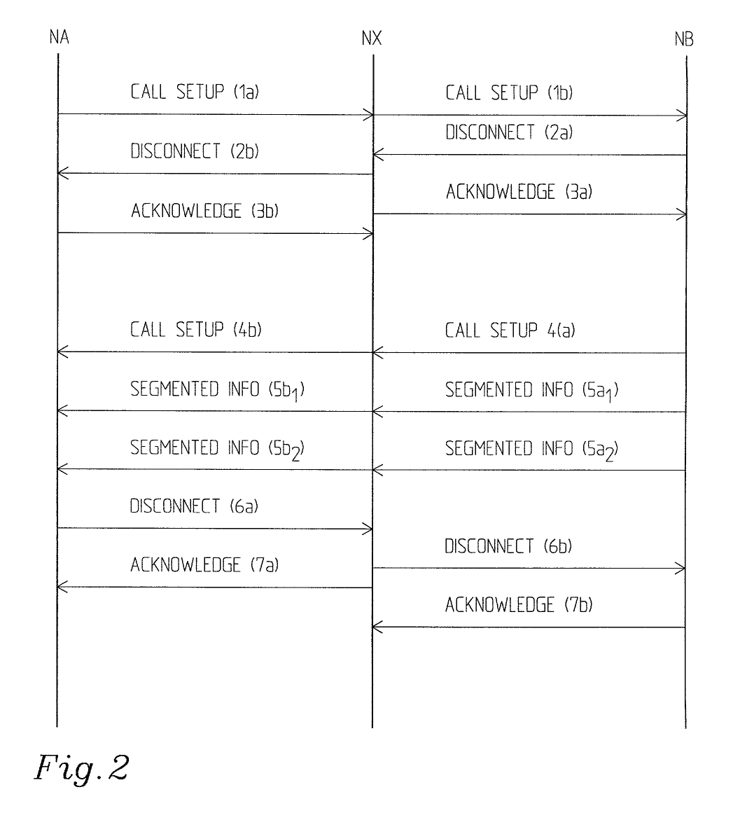

FIG. 1 is an illustration of the signalling that is performed in order to be able to send more information in the backward direction from a second switching arrangement NB to a first switching arrangement NA than can be contained in a single message. A call reference to a virtual call is then created in the first switching arrangement NA which particularly comprises system specific data such that NA and NB can communicate with each other and understand each other, but no other switching arrangements, particularly no transit switching arrangements, cf. FIG. 2, understand the content of the call reference. The call reference is then stored in NA and NA initiates a virtual call set up through sending a call set up message (1) to NB which contains information about the created call reference. The call reference is then stored in the destination switching arrangement NB which disconnects the call by sending a disconnect message (2) to NA. In NA all internal connections related to the virtual call, particularly the first virtual call, are kept but NA acknowledges the disconnection of the first virtual call through sending an acknowledge message (3) to NB. NB then initiates a new or second virtual call intended for NA and reuses the call reference previously created by NA. NB then sends a call set up message (4) to NA, including the stored call reference. When NA receives a call set up message (4) from NB, NA uses the received call reference (i.e. the initial call reference) and connects the new virtual call or the second virtual call to the kept internal connections. Then it is possible to send the information requested by NA or intended for NA as segmented messages. Now, the segmented messages are transferred (5₁, 5₂, 5₃) to NA. Segmented messages are sent until all information has been transferred. When all information is received, a disconnection of the (second) virtual call is initiated through sending of a disconnect message (6) from NA to NB. Then all connections are released in NB which sends an acknowledge message (7) to NA which then releases all its connections related to the virtual call.

FIG. 2 is a figure similar to FIG. 1, but wherein a transit exchange NX is supposed to be provided between NA and NB. As in the embodiment referred to in FIG. 1, a call reference is created in NA and the call reference is also stored in NA. NA then sends the call reference to the destination exchange, which is NB, and a call set up message (1a, 1b) is sent via NX. The call reference is stored in NB and the call is disconnected, disconnect message (2a, 2b) is sent via NX to NA. In NA all internal connections related to the virtual call are kept, and NA sends an acknowledge message (3b) to NX and all connections in NX are released and an acknowledge message (3a) is sent to NB. NB now initiates a new virtual call from NB to NA. The stored call reference is sent in call set up messages (4a, 4b). In NA the received call reference is used and a new call is connected to the kept internal connections. Then segmented messages (5a₁, 5b₁ and 5a₂, 5b₂) are sent until all information has been transferred. When all the information is received in NA, NA initiates a disconnection of the call through sending a disconnect message (6a) to NX which sends a disconnect message (6b) to NB which then releases all the connections related to the virtual call. An acknowledgement (7a) is sent from NX to NA which releases all connections related to the virtual call and an acknowledge message (7b) is also sent from NB to NX and all connections are released in NX. In other aspects the functioning is the same as that discussed with reference to FIG. 1.

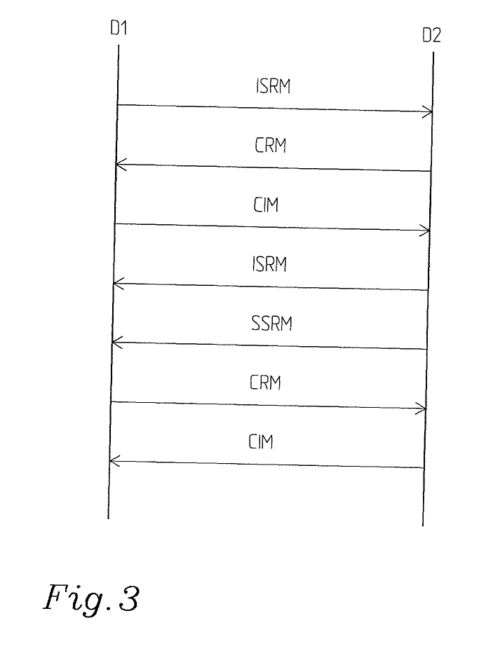

In FIG. 3 a particular implementation of a communications system using DPNSS 1 is illustrated. For call set up specific messages ISRM/SSRM are used and for call release CRM/CIM are used, as will be more thoroughly described below. According to the inventive concept it is also possible to add manufacturer specific information in DPNSS 1 messages.

As in the preceding embodiment a call reference is created and stored in exchange D1. It is sent as manufacturer specific data to exchange D2 by an ISRM (Initial Service Request Message) initiating a virtual call. D2 then stores the call reference and initiates a release of the virtual call by a CRM (Clear Request Message) but it keeps all internal connections. D1 acknowledges the release but keeps all internal connections. At this point all eventually seized transit exchanges (not shown) are released and only the end points are kept. An acknowledgement, a CIM (Clear Indication Message), is sent to D2.

D2 then initiates a new virtual call using the same call reference as in the previous virtual call initiated by D1. This is done through sending an ISRM (Initial Service Request Message) as discussed above. The actual information transfer can then start. In this direction, the so called backward direction, more than one message can be used for the information transfer, and a number of SSRMs (Subsequent Service Request Message) are sent. Subsequent SSRMs can carry the information as manufacturer specific data. When all the information has been received in D1, D1 releases the virtual call by sending a CRM (Clear Request Message) which is acknowledged by a CIM (Clear Indication Message) from D2 to D1.

The message types are further discussed in “Digital Private Network Signalling System No. 1 (DPNSS 1), BTNR 188, Section 4, Issue 6, Pages 1-25, January 1995, describing the message types and forms. This document is herewith incorporated herein by reference thereto. In BTNR 188, Section 15, Issue 4, Pages 1-8, December 1989, Supplementary Service, non-specified information describes the sending of non-specified information and how, for example, a supplementary information identifier can be included in call set up messages. This document is also incorporated herein by reference thereto. BTNR 188, Section 4, Annex 2, Issue 6, Pages 1-6, January 1995, describes coding and definition of supplementary information identifiers and BTNR 188, Section 6, Issue 6, Pages 3-12, describes simple telephony calls within DPNSS 1 and BTNR 188, Section 5, Issue 5, Page 17, December 1989, describes the concept of virtual calls within DPNSS 1. These documents are also incorporated herein by reference.

Particularly, the invention may be implemented for transfer of roaming information from a home location node or home location exchange of a mobile station roaming into another node or a visited node. The information may for example relate to authentication information which generally is too much information to be carried in one single message, why segmented messages are needed. Segmented messaging is allowed on set up of a virtual call, but not on a virtual call release as such. Therefore, segmented messages are not allowed following on a release, whereas a call set up is interpreted as an initiation signal enabling transmission of segmented messages. This is, however, solved through the inventive concept, through which the direction of a virtual call is changed through the setting up of another virtual call.

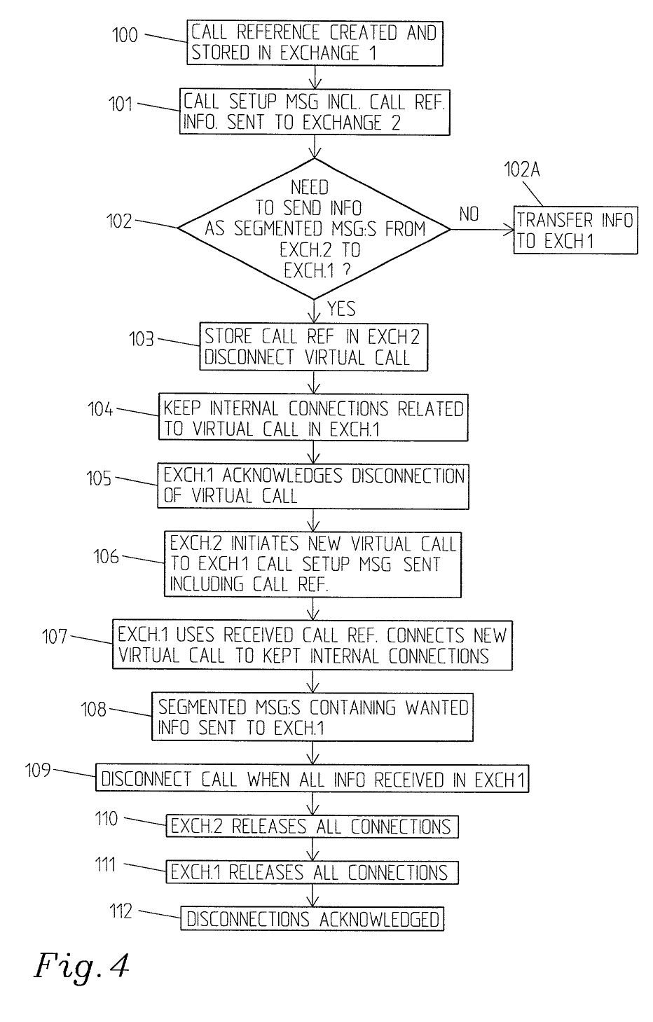

FIG. 4 illustrates a method in a flow diagram starting with the creation of a call reference in exchange 1, wherein the call reference also is stored, e.g. in a database 100. A call set up message relating to set up of a virtual call and including call reference information is then sent to exchange 2, 101. Then may e.g. be examined if there is a need to send information in segmented messages from exchange 2 to exchange 1, 102. If not, i.e. if there is only need for sending a short message which can be contained in one single message, the information is transferred to exchange 1, 102A. If, on the other hand, larger amounts of information are requested, the call reference is stored in storing means in exchange 2 and the virtual call is disconnected, 103. All the internal connections related to the virtual call are kept in exchange 1, 104 and exchange 1 acknowledges disconnection of the virtual call to exchange 2, 105. Exchange 2 then initiates a new virtual call intended for exchange 1 and a call set up message is sent, including the call reference that was created for the first virtual call (in the step 100), 106. Exchange 1 then uses the received call reference and connects the new virtual call to the kept internal connection, 107. Then segmented messages containing the wanted information are sent to exchange 1, 108. The call is disconnected when all information has been received in exchange 1, 109, and all connections are released in exchange 2, 110, whereupon exchange 1 releases all connections, 111. Finally, the disconnection is acknowledged, 112.

It is an advantage of the invention that more data than can be carried by a virtual call in the backward direction can be sent when the virtual call direction is changed or, in other words, if a second virtual call is set up in a direction opposite to that of the first virtual call. In for example DPNSS 1 up to 135 octets of data can be sent instead of 45 which is the limit for unsegmented messages, i.e. in the direction only allowing segmented messages, which would be the case if a second virtual call were not set up. This makes it possible to increase the capacity in a DPNSS 1 network since no speech channels need to be occupied for information transfer that can be carried out by virtual calls. This is, of course, also the case for other networks using asymmetrical protocols where limited information transfer is possible in one direction, but segmentation can be used in the opposite direction.

The invention is, of course, not limited to the explicitly illustrated embodiments, but it can be varied in a number of ways within the scope of the appended claims.

1. A private telecommunications system comprising a number of switching arrangements (NA, NB; NA, NX, NB) and using an asymmetrical protocol supporting set up of virtual calls between two switching arrangements (NA, NB) for transfer of information,
characterized in
that means are provided for creating a call reference in the first switching arrangement when a first virtual call is set up from the first switching arrangement to a second switching arrangement (NB), storing means being provided in said first and second switching arrangements (NA, NB) for storing said call reference, in that said first virtual call is released while all internal connections and the end points related to it are kept, and in that a second virtual call is set up in the direction opposite to that of the first virtual call using said call reference such that symmetrical transfer of information is enabled between the two switching arrangements (NA, NB).

2. A system according to claim 2,
characterized in
that segmented messages can be transferred both in the direction of the first virtual call and in the direction of the second virtual call.

3. A system according to claim 1 or 2,
characterized in
that the call reference comprises system specific data, and in that it is sent from the first (NA) to the second switching arrangement (NB) with a call set up message initiating the first virtual call.

4. A system according to claim 3,
characterized in
that the second switching arrangement (NB) sends a call release message to the first switching arrangement (NA) initiating release of the first virtual call, and in that the first switching arrangement (NA) acknowledges the release of the first virtual call but keeps the internal connections related to it.

5. A system according to claim 4,
characterized in
that the first virtual call is set up via a number of transit switching arrangements (NX), and in that connections to such transit exchanges are released upon acknowledgement of the release of the first virtual call by the first switching arrangement (NA).

6. A system according to any one of claims 1-5,
characterized in
that the second virtual call is initiated by the second switching arrangement (NB), and in that when said second virtual call is initiated, transfer of one or more information messages is started.

7. A system according to claim 6,
characterized in
that a call release message is sent from the first (NA) to the second switching arrangement (NB) when information transfer is detected to be completed.

8. A system according to any one of the preceding claims,
characterized in
that at least one switching arrangement (NA, NX, NB) is a PBX.

9. A system according to any one of claims 1-7,
characterized in
that at least one of the switching arrangements (NA, NB) is a mobility server acting as, or associated with, a PBX.

10. A system according to any one of the preceding claims,
characterized in
that the asymmetric protocol is DPNSS 1.

11. A system according to any one of the preceding claims,
characterized in
that the first switching arrangement (NA) is a node visited by a roaming mobile station, and in that the second switching arrangement (NB) comprises the home location node of the roaming mobile station, the information transferred to the first switching arrangement (NA) comprising at least authentication information relating to the mobile station.

12. A method for transfer of information between a first and a second switching arrangement in a private telecommunications system using an asymmetric protocol allowing a higher transmission capacity in one direction than in the other and supporting set up of virtual calls,
characterized in
that it comprises the steps of:
creating a call reference for a first virtual call in the first switching arrangement,
storing the call reference in the first switching arrangement,
sending the call reference to the second switching arrangement with a message initiating the first virtual call,
storing the call reference in the second switching arrangement, and
initiating a release of the first virtual call from the second switching arrangement,
keeping only the internal connections relating to the virtual call in the first and second switching arrangements,
initiating a second virtual call in the direction opposite to that of the first virtual call using the call reference of the first virtual call, and
initiating information transfer from the second to the first switching arrangements using one or more messages.

13. A method according to claim 12,
characterized in
that it comprises the step of, in at least one direction:
transferring segmentated messages upon initiation of a virtual call in the same direction as the virtual call is set up.

14. A method according to claim 12 or 13,
characterized in
that the step of creating a call reference comprises creating system specific data defining a call reference of a virtual call.

15. A method according to any one of claims 12-14,
characterized in
that it further includes the step of, at acknowledging the release of the first virtual call in the first switching arrangement:
releasing any transit exchange connection.

16. A method according to any one of claims 12-15,
characterized in
that it further comprises the step of:
releasing the second virtual call from the first switching arrangement when information transfer is completed.

17. A method according to any one of claims 12-16,
characterized in
that the telecommunications system uses the DPNSS protocol.

18. A method according to claim 17,
characterized in
that the amount of information that can be transferred as segmented data comprises up to 135 octets of data.

19. A method according to any one of claims 12-17,
characterized in
that the switching arrangements comprise PBX:es and/or mobility serving means including a PBX functionality or associated with a PBX, respectively.

20. A method according to any one of claims 12-19,
characterized in
that it comprises the step of:
setting up a first virtual call from a first switching arrangement into which a mobile station is roaming to a second switching arrangement containing home location data of the roaming mobile station,
transferring data requested, e.g. authentication information, by the first switching arrangement from the second to the said first switching arrangement.

21. A method for transfer of information between a first and a second switching arrangement in a private telecommunications system using an asymmetric protocol allowing a higher transmission capacity in one direction than in the other, opposite direction, and supporting set up of virtual calls,
characterized in
that it comprises the steps of:
setting up a first virtual call between the first and the second switching arrangement,
releasing the first virtual call,
using a call reference common with a call reference created of the first virtual call for setting up a second virtual call in the direction opposite to that of the first virtual call between the second and first switching arrangement,
using the second virtual call for transfer of information from the second to the first switching arrangement, such that symmetric transfer of information is enabled between the first and the second switching arrangement.
